(19) United States
(12) Patent Application Publication
(10) Pub. No.: US 2023/0151721 A1
(43) Pub. Date: May 18, 2023

(54) CLAMP CONNECTION FOR USE WITH FLOWLINES AND/OR COMPONENTS OF A HYDRAULIC FRACTURING OPERATION

(71) Applicant: BEST FLOW LINE EQUIPMENT, L.P., Fort Worth, TX (US)

(72) Inventors: Curtis THIERRY, Fort Worth, TX (US); Jeff PLAISTED, Fort Worth, TX (US)

(21) Appl. No.: 18/055,196

(22) Filed: Nov. 14, 2022

Related U.S. Application Data
(60) Provisional application No. 63/279,820, filed on Nov. 16, 2021.

(51) Int. Cl. E21B 43/26; F16L 23/04

(52) U.S. Cl. CPC E21B 43/26; F16L 23/04

(57) ABSTRACT

A clamp connection for use with flowlines of a hydraulic fracturing operation has a female clamp hub having a seal pocket formed in the face thereof, a male clamp hub having a raised face at an end thereof, an elastomeric seal received in the seal pocket of the female clamp hub, and a clamp connector extending around the female clamp hub and the male clamp hub so as to maintain the male clamp hub and the female clamp hub in a liquid-tight relationship. The male clamp hub has an annular protrusion extending outwardly of the raised face. The annular protrusion bears against a side of the elastomeric seal. The raised face of the male clamp hub is received in an interior of the female clamp hub.

### CROSS-REFERENCE TO RELATED APPLICATIONS

The present application claims priority from U.S. Provisional Patent Application Ser. No. 63/279,820, filed on Nov. 16, 2021, and entitled “Clamp Connection for Use with Flowlines and/or Components of a Hydraulic Fracturing Operation”.

### BACKGROUND OF THE INVENTION

### 1. Field of the Invention

The present invention relates to hydraulic fracturing operations. More particularly, the present invention relates to clamp connections used for joining components of such fracturing operations. More particularly, the present invention relates to clamp connections for joining flowlines and other components of a hydraulic fracturing operations.

### 2. Description of Related Art Including Information Disclosed Under 37 CFR 1.97 and 37 CFR 1.98.

In some oil field service operations, such as hydraulic fracturing, cementing, acidizing and the like, high-pressure fluids are pumped down the well. In some cases, the fluid pressures may be in excess of 15,000 p.s.i. Typically, an operator brings high-pressure pumping equipment to the well site and installs temporary service flowlines from the high-pressure pumps to the wellhead. Because high volumes of fluid may be needed, a number of pumping units may be connected together at one well site.

The temporary flowline components include joints or sections of steel pipe of differing lengths, various junctions, valves, swivels and the like. Generally, each well site differs, and the workers have to arrange the flowlines to extend around and past a variety of well site equipment. Many connections have to be made up, and each connection must be able to withstand the high-pressure forces. The workers need to be able to quickly make and break-out the connections to minimize the time for each job.

A hammer union is a common type of connector used for these temporary flowlines. The flowline components have ends that abut each other. A collar fits loosely on one end. The collar has internal threads for engaging threads on the end of the other flowline component. The collar has external lugs, and the workers deliver blows to the lugs to tighten the collars. While these hammer union systems work well, there are various disadvantages. The larger size components can be fairly heavy. The ends being joined have to be elevated above the ground to tighten the hammer union. A worker might sustain an injury while lifting the components and delivering blows with a hammer In very cold climates, the hammer union could shatter or break due to the blows. Sparks can be created by delivering the blows, which could create an explosion if any combustible gas has leaked in the vicinity. The task of connecting the components with a hammer union is also time-consuming.

Another type of temporary oilfield service flowline utilizes clamps to clamp the ends of the flowlines together. The workers employ wrenches to secure four bolts that draw the clamp halves together. The clamp engages annular external flanges formed on the ends of the flowline components. A cylindrical seal recess is formed in the bore at the end of each flowline component. The cylindrical recess terminates in a shoulder that is parallel to the end face of the flowline component. A cylindrical metal carrier ring fits within but does not seal to the cylindrical seal recess. Rather, a clearance exist between the recess and the carrier ring to facilitate entry of the carrier ring into the recess. Elastomeric seal rings are mounted to the carrier ring to seal against the cylindrical portions and shoulders of the recesses. This type of service flowline avoids the disadvantages of hammer unions, but is not in wide use.

In the clamp-type of temporary flowline mentioned above, the external dimensions of the clamps are fairly large because the external flanges protrude considerably more than the outer diameter of the flowline component. Reducing the size would make setting up flowlines more convenient because of compactness. However, the high-pressure ratings mandate a certain amount of support metal and still must be maintained.

Another type of flowline connector uses clamps that are secured to the tubular members. In that type, the seal ring has conical surfaces that form metal-to-metal seals with conical surfaces formed in the passages of the tubular members. While able to sustain high pressures, these connectors are not normally used for oilfield service work because the metal seals would not withstand daily make-up and break-out. The metal-to-metal seals also become very difficult to remove and replace. As such, the various components are utilized in a one-use manner. It would be desirable, in the field, that the components would be able to be separated from each other, reattached, and reused. As such, a need has developed so as to avoid the use of such metal-to-metal seals in such hydraulic fracturing flowlines.

In the past, a variety of patents have issued with respect to these clamp connections used in hydraulic fracturing operations. For example, an early patent directed to engaging tubular members together is shown in U.S. Pat. No. 2,766,999, issued on Oct. 16, 1956 to Watts et al. This patent describes a conduit connection with conically-formed inter-engaging seats on seal and connection members. A unitary continuous sealing ring of hard metal is utilized. This unitary continuous sealing ring comprises an inner annular flange portion with oppositely disposed flexible lips and an integral substantially centrally disposed external rib portion. The lips have exterior sealing surfaces which taper outwardly toward the rib portion at an angle not exceeding 35° with respect to the longitudinal axis of the sealing ring. The tapered lips are undercut at the juncture points of the exterior sealing surfaces with the rib portion.

U.S. Pat. No. 3,216,746, issued on Nov. 9, 1965 to J. D. Watts, teaches a sealing ring component having first and second annular parts having annular end surfaces presented toward one another in coaxial alignment. There is a conically tapered radially inwardly facing sealing surface on each of the annular parts. The sealing surfaces each extend at an acute angle with respect to the longitudinal axis of the parts and increase in radius toward the annular end surfaces. The sealing surfaces join the annular end surfaces at the radially inner extent of the annular end surface. An annular sealing ring of hard metal or the like provides a seal between the parts when they are drawn toward one another. The sealing ring has a radially inner annular flange portion having a pair of oppositely-disposed annular flexible lips with an integral substantially centrally disposed annular rib portion having a pair of oppositely axially facing end surfaces.

U.S. Pat. No. 4,218,080, issued on Aug. 19, 1980 to W. D. Kendrick, discloses a repairable composite seal ring for a conduit connection. The seal assembly has first and second conduit parts. Each of the conduit parts has an axially extending flow passage and an end surface radially intersecting the flow passage. Each of the conduit parts has an internal sealing cavity adjacent the end surface and radially offset from the flow passage. A composite annular seal is interposed between the conduit parts and extends into the two sealing cavities. The composite annular seal includes a central rim portion from which extend two generally axially-disposed lip portions projecting oppositely outwardly into the conduit sealing cavities. Each lip portion has an annular groove therein.

U.S. Pat. No. 6,832,789, issued on Dec. 21, 2004 to K. L. Church, shows a threaded pipe connection with a cylindrical metal-to-metal high-pressure containment seal. This connection utilizes a separate ramp or ramp regions that simulate a pin swaging or a box expansion which results in the ability of the cylindrical components of the seal to assemble without interference with only slight interference.

U.S. Pat. No. 7,204,525, issued on Apr. 17, 2007 to M. D. Matzner, shows a flowline connection assembly that connects first and second tubular members to each other. Each tubular member has a proximal flange on its end. The conical recess is formed in the bore at the ends of each of the tubular members. A metal ring has a pair of legs extending in opposite axial directions. Each of the legs has a conical outer surface that engages one of the conical recesses. Each ring has an elastomeric seal that seals the recess. A clamp has cam surfaces that engage the flanges and pulls the tubular members axially toward each other.

U.S. Pat. No. 7,549,681, issued on Jun. 23, 2009 to M. D. Matzner, describes a flowline connection assembly that connects first and second tubular members to each other. Each tubular member has an external flange on its end. A recess is formed in the bore at the end of each of the tubular members. A seal ring extends into each of the conical recesses. A clamp with a pair of halves includes cam surfaces that engage the flanges and pulls the tubular members axially toward each other. Bolts extend from one clamp half to the other. A retainer ring on each bolt retains the bolts with one of the clamp halves.

U.S. Pat. No. 7,823,265, issued on Nov. 2, 2010 to Matzner et al., teaches a flowline torque arm assembly for removing a pair of flowline members relative to each other. This assembly has a pair of flowline collars that are adapted to connect to an end portion of one of the pair of flowline members. The assembly has an arm member with an end portion rotationally mounted to one of the flowline collars and a connecting member pivotally mounted to the other flowline collar. The connecting member is pivotally mounted to the arm member a distance away from the end portion of the arm member that is connected to the flowline collar so that rotational movement of the arm member moves the flowline members relative to each other.

U.S. Pat. No. 8,978,695, issued on Mar. 17, 2015 to Witkowski et al., teaches a check valve assembly that has a body with the central cavity intersected by upstream and downstream flow passages. A seat is secured by a threaded engagement in the upstream flow passage. An access bore intersects the cavity and has a support shoulder formed in it. A holder is supported on the support shoulder. A flapper is pivotally secured to the holder and is located in the cavity for movement between an open position and a closed position. A straight edge portion in the access bore engages a straight edge portion of the holder to prevent rotation of the holder. A fastener extends through a hole in the support shoulder into engagement with the seat to prevent rotation of the seat.

It is an object of the present invention to provide a clamp connector that minimizes the effects of external loads and vibrations from the pump systems.

It is another object of the present invention to provide a clamp connector that avoids cracks in the connections between flowlines and other components of a hydraulic fracturing system.

It is another object of the present invention to provide a clamp connector that does not require metal-to-metal seals.

It is another object of the present invention provide a clamp connector that can be reused.

It is another object of the present invention to provide a clamp connector that has a more robust sealing action.

It is still another object of the present invention to provide a clamp connector that has a substantially greater lifetime of use.

It is another object of the present invention to provide a clamp connector that is cost-effective.

It is a further object of the present invention to provide a clamp connector that is able to be used at various locations of a flowline.

It is a further object of the present invention to provide a clamp connector that avoids damage to seal surfaces.

These and other objects and advantages of the present invention will become apparent from a reading of the attached specification and appended claims.

### BRIEF SUMMARY OF THE INVENTION

The present invention is clamp clamp connection for use with flowlines of a hydraulic fracturing operation. This clamp connection includes a female clamp hub having a seal pocket formed in a face thereof, a male clamp hub having a raised face at an end thereof and having an annular protrusion extending outwardly of the raised face, an elastomeric seal received in the seal pocket of the female clamp hub, and a clamp connector extending around the female clamp hub and the male clamp hub so as to maintain the male clamp hub and the female clamp hub in liquid-tight relationship. The annular protrusion bears against the side of the elastomeric seal. The raised face of the male clamp hub is received an interior of the female clamp hub.

The female clamp hub has an end face that bears against end face of the male clamp hub. The female clamp hub and the male clamp of each have an annular flange formed at an outer diameter thereof. The clamp connector is engaged with both of the annular flanges of the female clamp hub and the male clamp hub. The female clamp hub has a recessed area formed inwardly of the end face thereof. The raised face of the male clamp hub is received in the recessed area of the female clamp. The annular protrusion of the male clamp hub extends at least partially into the seal pocket of the female clamp.

The elastomeric seal has an anti-extrusion ring at an outer diameter thereof. The annular protrusion bears against this anti-extrusion ring.

The female clamp hub and the male clamp hub each have an interior passageway axially aligned with each other. The elastomeric seal has an inner diameter facing the interior passageway of the female clamp hub. The interior passageway of the female clamp hub has a wall and the interior passageway of the male clamp hub has a wall. The inner diameter of the elastomeric seal is generally flush with or recessed from the walls of the male clamp hub and the female clamp hub.

In the various embodiments of the present invention, various components can be connected by way of the clamp connection of the present invention. In one embodiment, a swivel joint is connected to the one of the male clamp hub and the female clamp hub and a check valve is connected to another of the male clamp hub and the female clamp hub. In another embodiment, a swivel joint is connected to the one of the male clamp hub and the female clamp hub and a pipe section is connected to another of the male clamp hub and the female clamp hub. In another embodiment of the present invention, a check valve is connected to the one of the male clamp hub and the female clamp hub and a pipe section is connected to another of the male clamp hub and the female clamp hub. In still a further embodiment of the present invention, a first pipe section is connected to one of the male clamp hub and the female clamp hub and a second pipe section is connected to another of the male clamp hub and the female clamp hub.

The clamp connector of the present invention includes a first semi-annular member extending around a portion of the annular flanges of the male clamp hub and the female clamp hub and a second semi-annular member extends around another portion of the annular flanges of the male clamp hub and the female clamp hub. The first semi-annular member has bolt holes extending outwardly therefrom. The second semi-annular member has bolt holes extending outwardly therefrom. The bolt holes of the second semi-annular member are axially aligned with the bolt holes of the first semi-annular member. A bolt is received in each of the aligned pairs of bolt holes of the first semi-annular member and the second semi-annular member. The bolt is tightable so as to draw the end faces of the male clamp hub and the female clamp hub together. The annular protrusion applies a compression force against the elastomeric seal when the end faces are drawn together.

This foregoing Section is intended to describe, with particularity, the preferred embodiments of the present invention. It is understood that modifications to these preferred embodiments can be made within the scope of the present claims. As such, this Section should not to be construed, in any way, as limiting of the broad scope of the present invention. The present invention should only be limited by the following claims and their legal equivalents.

### BRIEF DESCRIPTION OF THE SEVERAL VIEWS OF THE DRAWINGS

FIG. 1 is a cross-sectional view of the clamp connection of the present invention.

FIG. 2 is an exploded view of the clamp connection of the present invention.

FIG. 3 is a detailed view showing circled area “3” of FIG. 2.

FIG. 4 is an exploded perspective view showing the configuration of the male clamp hub.

FIG. 5 is an exploded upper perspective view of the female clamp hub of the present invention.

FIG. 6 is an upper perspective view showing the complete assembly of the clamp connection of the present invention.

### DETAILED DESCRIPTION OF THE INVENTION

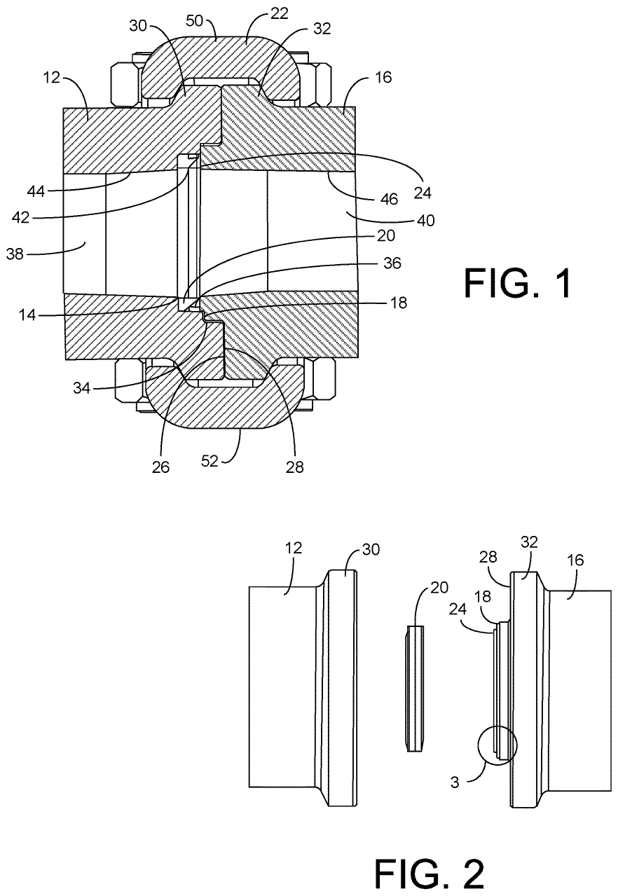

Referring to FIG. 1, there is shown the clamp connection 10 in accordance with the teachings of the present invention. The clamp connection 10 includes a female clamp hub 12 having a seal pocket 14 formed therein, a male clamp hub 16 having a raised face 18 formed at an end thereof, an elastomeric seal 20 received in the seal pocket 14 of the female clamp hub 12, and a clamp connector 22 extending around the female clamp hub 12 and the male clamp hub 16 so as to maintain the male clamp hub 16 and the female clamp hub 12 in a liquid-tight relationship. The male clamp hub 16 has an annular protrusion 24 extending outwardly of the raised face 18. This annular protrusion 24 bears against a side of the elastomeric seal 20. The raised face 18 of the male clamp hub 16 is received in an interior of the female clamp hub 12.

The female clamp hub 12 has an end face 26 that bears against an end face 28 of the male clamp hub 16. The female clamp hub has an annular flange 30 formed at an outer diameter thereof. The male clamp hub 16 also has an annular flange 32 formed at an outer diameter thereof. The clamp connector 22 is engaged with both of the annular flanges 30 and 32 of the female clamp hub 12 and the male clamp hub 16.

The female clamp hub 12 has a recessed area 34 formed inwardly of the end face 26 thereof. The raised face 18 of the male clamp hub 16 is received in this recessed area 34 of the female clamp hub 12. It can be seen that the annular protrusion 24 of the male clamp hub 16 extends at least partially into the seal pocket 14 of the female clamp hub 12.

The elastomeric seal 20 has an anti-extrusion ring 36 at an outer diameter thereof. The annular protrusion 24 bears against this anti-extrusion ring 36.

The female clamp hub 12 has an interior passageway 38. The male clamp hub 16 also has an interior passageway 40. The interior passageway 38 of the female clamp hub 12 is axially aligned with the interior passageway 40 of the male clamp hub 16. The elastomeric seal 24 has an inner diameter 42 that faces the interior passageway 38 of the female clamp hub 12. The interior passageway 38 of the female clamp hub 12 has a wall 44. The interior passageway 40 of the male clamp hub 16 also has a wall 46. The inner diameter 42 of the elastomeric seal 20 is generally flush with or recessed from the walls 44 and 46 of the female clamp hub 12 and the male clamp hub 16.

In normal use, the female clamp hub 12 and the male clamp hub 16 can be joined the various components of a hydraulic fracturing system. In one embodiment, a swivel joint can be connected to one of the male clamp hub 16 and the female clamp hub 12 and a check valve can be connected to another of the male clamp hub 16 and the female clamp hub 12. In another embodiment, a swivel joint can be connected to one of the male clamp hub 16 and the female clamp hub 12 while a pipe section is connected to another of the male clamp hub 16 and the female clamp hub 12. In another embodiment, a check valve can be connected to one of the male clamp hub 16 and the female clamp hub 12 while a pipe section can be connected to another of the male clamp hub 16 and the female clamp hub 12. In still a further embodiment of the present invention, a first pipe section to be connected to one of the male clamp hub 16 and the female clamp hub 12 while a second pipe section is connected to another of the male clamp hub 16 and the female clamp hub 12.

FIG. 1 shows a configuration of a cross-section of the clamp connector 22. The clamp connector 22 is of a configuration of a clamp connector currently manufactured by Greyloc. This clamp connector includes a first semi-annular member 50 extending around a portion of the annular flanges of the male clamp hub 16 and the female clamp hub 12. There is a second semi-annular member 52 that extends around another portion of the annular flanges 30 and 32 of the female clamp hub 12 and the male clamp hub 16. When the first and second semi-annular members 50 and 52 are drawn together, the tapered relationship between the outer surfaces of the flanges 30 and 32 will cause the end faces 26 and 28 to be drawn together in order to create a liquid-tight seal between the female clamp hub 12 and the male clamp hub 16. When this liquid-tight relationship is achieved, the annular protrusion 24 will exert a compression force against the elastomeric seal 20.

In this configuration of the present invention, the use of the elastomeric seal, as opposed to metal-to-metal seals minimizes the effects of external loads and vibrations associated with pump systems. The elastomeric seal will tend to absorb many of these vibrations so that the vibrations do not pass entirely from one component to another component. This somewhat flexible and shock-absorbing connection avoids cracks in the connection that would otherwise occur by a metal-to-metal seal. The present invention entirely avoids such metal-to-metal seals. The use of the elastomeric seal 20, along with a clamp connector 22, allows the clamp connection to be reused. The engagement between the annular protrusion 24 and the elastomeric seal 20 establishes a more robust sealing configuration. The arrangement of the present invention allows the clamp connection to have a longer life than that of metal-to-metal seals. The use of the elastomeric seal 20, in combination with the annular protrusion 24, is very cost effective. The configuration of the clamp connection of the present invention allows it to be used in various locations along a flowline. This configuration also avoids damage to the various seal surfaces which could otherwise occur through the use of metal-to-metal seals.

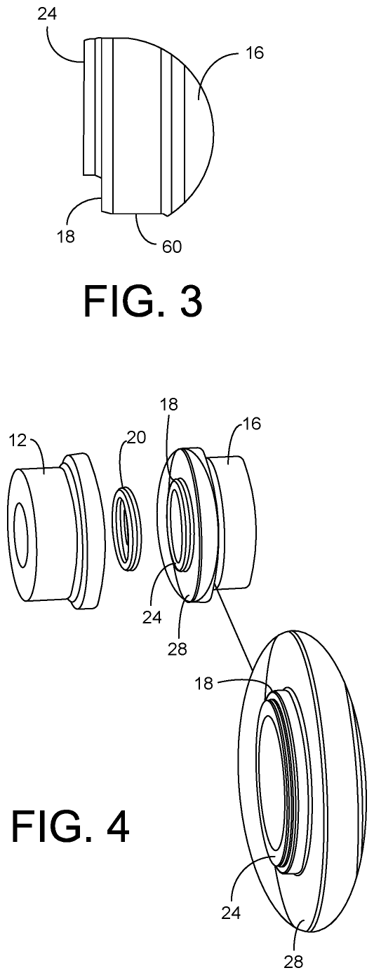

FIG. 2 illustrates the relationship between the female clamp hub 12 and the male clamp hub 16. It can be seen that the female clamp hub 12 includes annular flange 30 extending outwardly therefrom. Male clamp hub 16 has annular flange 32 extending outwardly therefrom. The female clamp hub 32 includes a seal pocket (not illustrated) which is adapted to receive the elastomeric seal 20 therein. The male clamp hub 16 includes a raised face 18 that extends outwardly from the face 28 thereof. The annular protrusion 24 extends outwardly of the raised face 18.

FIG. 3 shows a detailed view of the relationship between the raised face 18 and the annular protrusion 24. It can be seen that the annular protrusion 24 has an outer diameter slightly less than the outer diameter of the raised face 18. The raised face 18 has a portion 60 that extends toward the body of the male clamp hub 16. The raised face 24 will extend into the seal pocket 14 so as to bear against a side of the elastomeric seal 20 in order to provide a strong sealing force thereagainst.

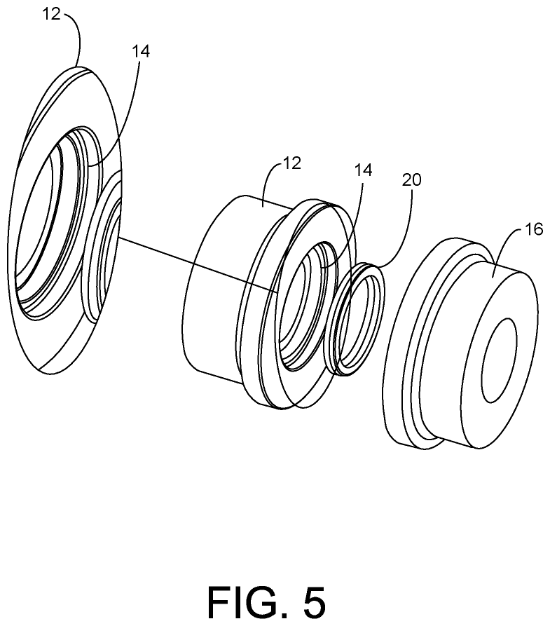

FIG. 4 shows a further view of the relationship between the female clamp hub 12 and the male clamp hub 16. In particular, it can be seen that the raised face 18 extends outwardly of the face 28 of the male clamp hub 16. The annular protrusion 24 extends slightly outwardly of the raised face 18. The annular protrusion 24 is generally aligned with the size and diameter of the elastomeric ring 20.

FIG. 5 shows the configuration of the seal pocket 14 of the female clamp hub 12. The elastomeric ring 20 is received into the interior of the seal pocket 12. The interior surfaces within the seal pocket 14 will bear against the side of the elastomeric ring 20 so as to provide a strong sealing force thereagainst. The male clamp hub 16 is positioned so as to be aligned with the female clamp hub 12.

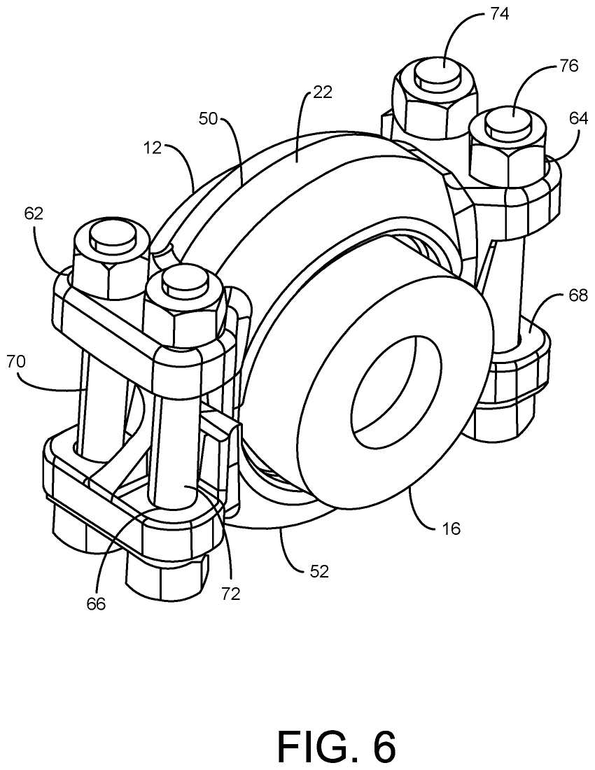

FIG. 6 illustrates how the clamp connector 22 is configured so as to join the female clamp hub 12 with the male clamp hub 16. In particular, the clamp connector 22 includes a first semi-annular member 50 and a second semi-annular member 52 that are positioned over the respective annular flanges 30 and 32 of female clamp connector 12 and male clamp connector 16 in a manner shown in FIG. 1 hereinabove. The first semi-annular member 50 has bolt holes 62 and 64 extending outwardly therefrom. The second semi-annular member 52 also has bolt holes 66 and 68 extending outwardly therefrom. Bolts 70 and 72 are received in the bolt holes 62 and 66. Bolts 74 and 76 are received in the bolt holes 64 and 68. The bolt holes of the first semi-annular member 50 are axially aligned with the bolt holes of the second semi-annular member 52. The bolts 70, 72, 74 and 76 are suitably tightenable so as to draw the first and second semi-annular members 50 and 52 together so as to apply a strong force against the annular flanges of the female clamp hub 12 and the male clamp hub 16 in order to draw the end faces together. When this is accomplished, the annular protrusion applies a compression force against the elastomeric seal.

The foregoing disclosure and description of the invention is illustrative and explanatory thereof. Various changes in the details of the illustrated construction can be made within the scope of the appended claims without departing from the true spirit of the invention. The present invention should only be limited by the following claims and their legal equivalents.

We claim:

1. A clamp connection for use with flowlines of a hydraulic fracturing operation, the clamp connection comprising:
a female clamp hub having a seal pocket formed in a face thereof;
a male clamp hub having a raised face at an end thereof, said male clamp hub having an annular protrusion extending outwardly of the raised face;
an elastomeric seal received in the seal pocket of said female clamp hub, said annular protrusion bearing against a side of said elastomeric seal, the raised face of said male clamp hub being received in an interior of said female clamp hub; and
a clamp connector extending around said female clamp hub and said male clamp hub so as to maintain said male clamp hub and said female clamp hub in a liquid-tight relationship.

2. The clamp connection of claim 1, said female clamp hub having an end face that bears against an end face of said male clamp hub.

3. The clamp connection of claim 1, said female clamp hub and said male clamp hub each having an annular flange formed at an outer diameter thereof, said clamp connector being engaged with both of the annular flanges of said male clamp hub and said female clamp hub.

4. The clamp connection of claim 2, said female clamp hub having a recessed area formed inwardly of the end face thereof, the raised face of said male clamp hub being received in the recessed area of said female clamp.

5. The clamp connection of claim 1, the annular protrusion of said male clamp hub extending at least partially into the seal pocket of said female clamp.

6. The clamp connection of claim 1, said elastomeric seal having an anti-extrusion ring at an outer diameter thereof

7. The clamp connection of claim 6, said annular protrusion bearing against the anti-extrusion ring.

8. The clamp connection of claim 1, said female clamp hub having an interior passageway, said male clamp hub having an interior passageway axially aligned with the interior passageway of said female clamp hub.

9. The clamp connection of claim 8, said elastomeric seal having an inner diameter facing the interior passageway of said female clamp hub.

10. The clamp connection of claim 9, the interior passageway of said female clamp hub having a wall, the interior passageway of said male clamp hub having a wall, the inner diameter of said elastomeric seal being generally flush with or recessed from the walls of said male clamp hub and said female clamp.

11. The clamp connection of claim 1, further comprising:
a swivel joint connected to one of said male clamp hub and said female clamp hub; and
a check valve connected to another of said male clamp hub and said female clamp.

12. The clamp connection of claim 1, further comprising:
a swivel joint connected one of said male clamp hub and said female clamp hub; and
a pipe section connected to another of said male clamp hub and said female clamp hub.

13. The clamp connection of claim 1, further comprising:
a check valve connected to one of said male clamp hub and said female clamp hub; and
a pipe section connected to another of said male clamp hub and said female clamp hub.

14. The clamp connection of claim 1, further comprising:
a first pipe section connected to one of said male clamp hub and said female clamp hub; and
a second pipe section connected to another of said male clamp hub and said female clamp hub.

15. The clamp connection of claim 3, said clamp connector comprising:
a first semi-annular member extending around a portion of the annular flanges of said male clamp hub and said female clamp hub, said first semi-annular member having bolt holes extending outwardly therefrom;
a second semi-annular member extending around another portion of the annular flanges of said male clamp hub and said female clamp hub, said second semi-annular member having bolt holes extending outwardly therefrom, the bolt holes of said second semi-annular member being axially aligned with the bolt holes of said first semi-annular member; and
a bolt received in each of the aligned pairs of bolt holes of said first semi-annular member and said second semi-annular member, said bolt being tightable so as to draw the end faces of said male clamp hub and said female clamp hub together.

16. The clamp connection of claim 15, the annular protrusion applying a compression force against said elastomeric seal when the end faces are drawn together.

17. A clamp connection system comprising:
a female clamp hub having a seal pocket formed in the face thereof;
a male clamp hub having a raised face at an end thereof, said male clamp hub having an annular protrusion extending outwardly of the raised face;
an elastomeric seal received in the seal pocket of said female clamp hub, said annular protrusion bearing against the side of said elastomeric seal, the raised face of said male clamp hub being received in an interior of said female clamp hub;
a clamp connector extending around said female clamp hub and said male clamp hub so as to maintain said male clamp hub and said female clamp hub in a liquid-tight relationship;
a swivel joint connected to one of said male clamp hub and said female clamp hub; and
a pipe section connected to another of said male clamp hub and said female clamp hub.

18. The clamp connection of claim 17, said female clamp hub having an end face that bears against an end face of said male clamp hub, said female clamp hub and said male clamp hub each having an annular flange formed at an outer diameter thereof, said clamp connector being engaged with both of the annular flanges of said male clamp hub and said female clamp hub.

19. A clamp connection system comprising:
a female clamp hub having a seal pocket formed in a face thereof;
a male clamp hub having a raised face at an end thereof, said male clamp hub having an annular protrusion extending outwardly of the raised face;
an elastomeric seal received in the seal pocket of said female clamp hub, said annular protrusion bearing against a side of said elastomeric seal, the raised face of said male clamp hub being received in an interior of said female clamp hub;
a clamp connector extending around said female clamp hub and said male clamp hub so as to maintain said male clamp hub and said female clamp hub in a liquid-tight relationship;
a first pipe section connected to one of said male clamp hub and said female clamp hub; and
a second pipe section connected to another of said male clamp hub and said female clamp hub.

20. The clamp connection of claim 19, said female clamp hub having an end face that bears against an end face of said male clamp hub, said female clamp hub and said male clamp hub each having an annular flange formed at an outer diameter thereof, said clamp connector being engaged with both of the annular flanges of said male clamp hub and said female clamp hub.
